(19) United States
(12) Patent Application Publication
(10) Pub. No.: US 2013/0169411 A1
(43) Pub. Date: Jul. 4, 2013

(54) METHOD FOR OPERATING AN ELECTRONIC LOCK

(71) Applicant: TAIWAN FU HSING INDUSTRIAL CO., LTD., Kaohsiung City (TW)

(72) Inventors: Tien-Fu Chan, Kaohsiung City (TW); Shih-Min Lu, Kaohsiung City (TW); Lien-Hsi Huang, Kaohsiung City (TW)

(73) Assignee: TAIWAN FU HSING INDUSTRIAL CO., LTD., Kaohsiung City (TW)

(21) Appl. No.: 13/733,148

(22) Filed: Jan. 3, 2013

(30) Foreign Application Priority Data
Jan. 3, 2012 (TW) 101100255

(51) Int. Cl. G05B 1/00

(52) U.S. Cl. CPC G05B 1/00
USPC 340/5.54; 340/5.51

(57) ABSTRACT

A method for operating an electronic lock is disclosed. The electronic lock includes a processing unit, an inner body and an outer body. The inner body includes an inner input portion, and the outer body includes an input device. The method includes operating the inner input portion of the inner body to output various signals according to operation of the inner input portion, wherein the various signals comprises a first signal and utilizing the input device to log in a manage menu of the electronic lock when the processing unit receives the first signal, wherein the manage menu of the electronic lock comprises a first controlling item for setting a left-handed mode or a right-handed mode by the input device.

### BACKGROUND OF THE INVENTION

1. Field of the Invention

The present invention relates to a method for operating an electronic lock, and more particularly, to a method for operating an electronic lock adapted to a left-handed door or a right-handed door.

2. Description of the Prior Art

Generally speaking, a key is often used for locking and unlocking a door. However, the key is often missed, so as to cause inconvenience in use. An electronic lock has been developing for providing a solution to lock and unlock the door without using the key. For example, U.S. Pat. No. 5,347,267, Japan Patent No. 2002-235470 and Japan Patent No. 2005-213994 disclose related technology about the electronic lock.

Conventionally, there are left-handed doors and right-handed doors for indoor design. The corresponding electronic lock is designed for the above-mentioned left-handed door or the right-handed door. However, installing directions of the electronic lock adapted to the left-handed door and the right-handed door are different. Thus, when taking an unmatched electronic lock, or when the opening side of the door plank is switched due to the changed spatial planning, the existing electronic lock is not applicable, so as to cause inconvenience of the electronic lock in use.

### SUMMARY OF THE INVENTION

Thus, the present invention provides a method for operating an electronic lock by utilizing a management menu and a related electronic lock for solving above drawbacks.

The present invention discloses a method for operating an electronic lock. The method includes operating the inner input portion of the inner body to output various signals according to operation of the inner input portion, wherein the various signals comprises a first signal and utilizing the input device to log in a manage menu of the electronic lock when the processing unit receives the first signal, wherein the manage menu of the electronic lock comprises a first controlling item for setting a left-handed mode or a right-handed mode by the input device.

In summary, the only way to log in the management menu of the electronic lock is to operate the inner input portion of the inner body, i.e. the management menu of the electronic lock can not be logged in by operation of the outer body. It can prevent a thief from logging in the management menu of the electronic lock by operating the outer body, so as to enhance security of the electronic lock. In addition, the electronic lock can to be switched to the left-handed mode or to the right-handed mode by operating the input device and the management menu of the electronic lock. Accordingly, since the electronic lock is capable of being installed on a left-handed door as well as a right-handed door by switching the electronic lock to be in the corresponding mode, it can enhance convenience of installation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an electronic lock according to an embodiment of the present invention.

FIG. 2 is a diagram of the electronic lock in another view according to the embodiment of the present invention.

FIG. 3 is a flowchart of a method for operating the electronic lock according to the embodiment of the present invention.

FIG. 4 is a diagram illustrating that the electronic lock is installed on a left-handed door according to the embodiment of the present invention.

FIG. 5 is a diagram illustrating that the electronic lock is installed on a right-handed door according to the embodiment of the present invention.

FIG. 6 to FIG. 9 are respectively diagrams illustrating that the electronic lock is installed on the right-handed door according to the embodiment of the present invention.

FIG. 10 to FIG. 13 are respectively diagrams illustrating the electronic lock in a stretched status is installed on the right-handed door according to the embodiment of the present invention.

FIG. 14 to FIG. 17 are respectively diagrams illustrating the electronic lock in a constrained status is installed on the left-handed door according to the embodiment of the present invention.

FIG. 18 to FIG. 21 are respectively diagrams illustrating the electronic lock in the constrained status is installed on the right-handed door according to the embodiment of the present invention.

### DETAILED DESCRIPTION

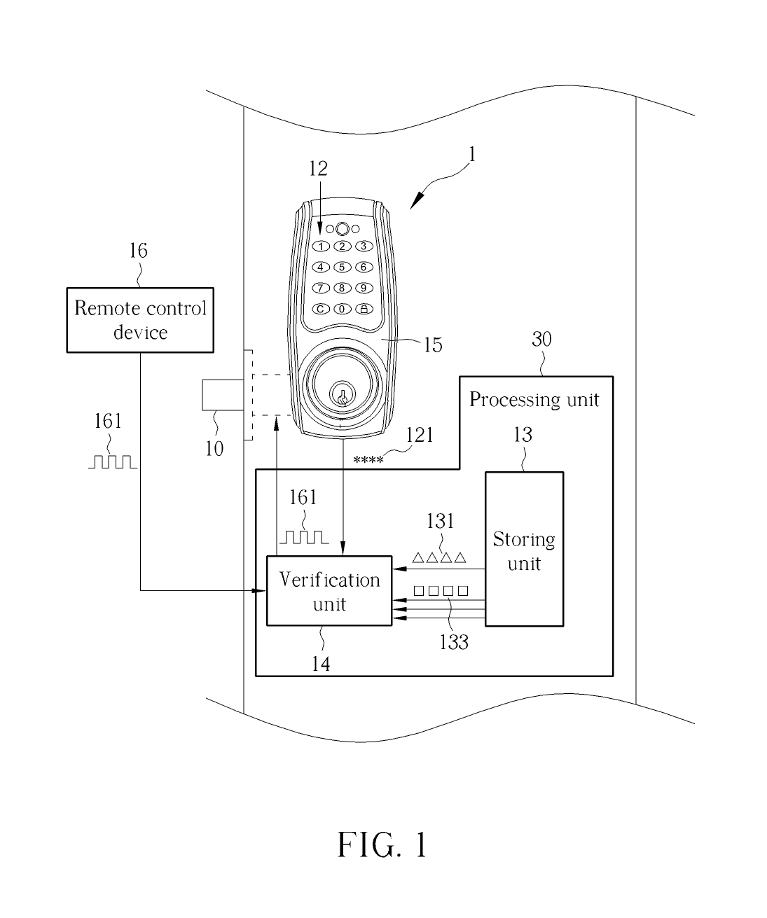

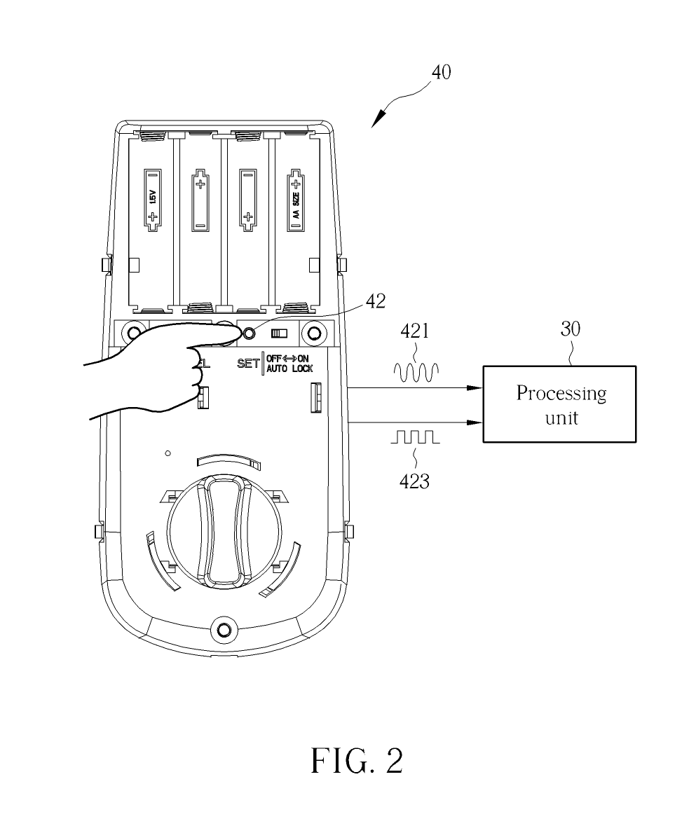

Please refer to FIG. 1 and FIG. 2. FIG. 1 is diagram of an electronic lock 1 according to an embodiment of the present invention. FIG. 2 is diagram of the electronic lock 1 in another view according to the embodiment of the present invention. As shown in FIG. 1 and FIG. 2, the electronic lock 1 includes a locking mechanism 10, an input device 12, an outer body 15 and at least one remote control device 16. In this embodiment, the outer body 15 can be a panel. The input device 12 is disposed on the outer body 15 and used for inputting a verification password 121, such as numeral passwords.

Furthermore, the electronic lock 1 further includes a processing unit 30 and an inner body 40. The processing unit 30 includes a storing unit 13 and a verification unit 14. The storing unit 13 is used for storing a master password 131 and at least one user password 133. The verification unit 14 is used for determining whether the verification password 121 matches the master password 131 or the user password 133. The inner body 40 includes an inner input portion 42. The remote control device 16 is used for transmitting an unlocked signal 161 to the processing unit 30.

In this embodiment, the locking mechanism 10 can be a deadbolt structure instead of a latch structure, and the input device 12 can be, but not limited to, a keyboard for inputting the verification password 121. For example, the input device 12 can be a mobile device, a data storage drive, a card reader, a camera, a finger print recognition system, an iris recognition system, a voice recognition system, a facial expression detector, or a biometric recognition system. Accordingly, the input devices 12 mentioned above can be used for inputting at least one or a combination of the verification passwords 121 selected from a group consisting of a numeral, a pattern, a motion, a gesture, a finger print, an iris feature, a sound, a facial expression, and a biometric characteristic. As for which one of the above-mentioned designs is adopted, it depends on practical demands.

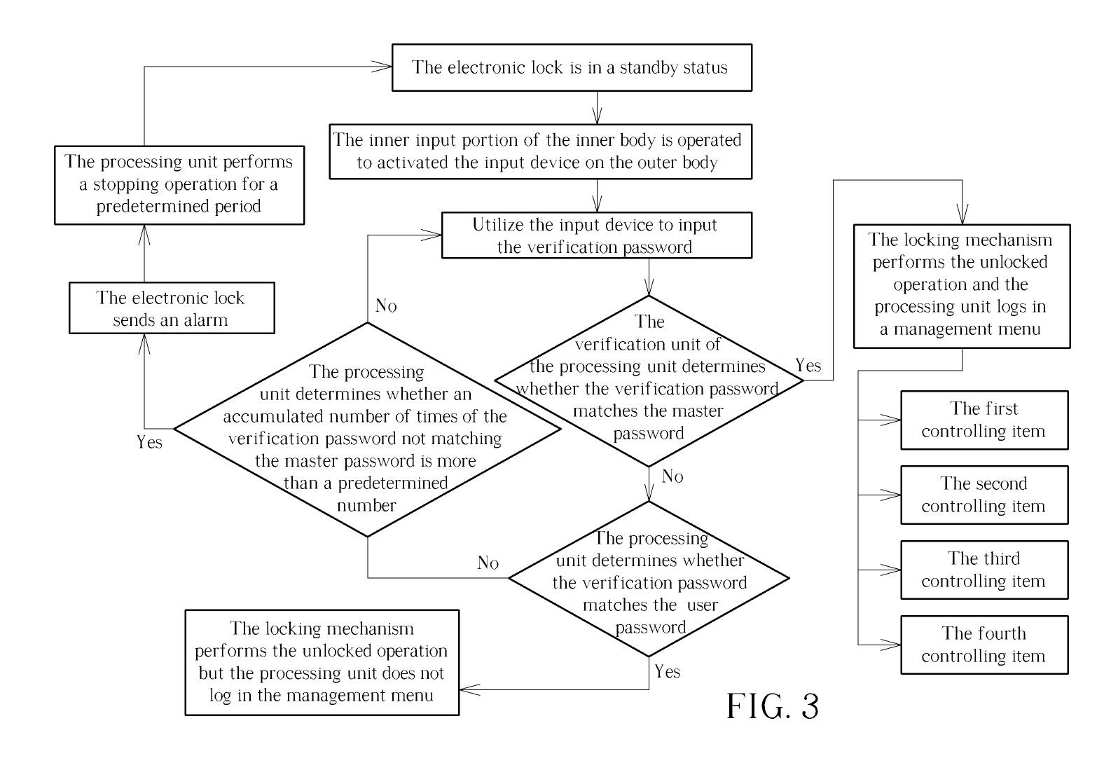

Please refer to FIG. 3. FIG. 3 is a flowchart of a method for operating the electronic lock 1 according to the embodiment of the present invention. At first, the electronic lock 1 is powered on and remains in a standby status. When the electronic lock 1 is desired to be operated, the inner input portion 42 of the inner body 40 is operated and outputs various signals according to operation of the inner input portion 42, wherein the inner input portion 42 outputs a first signal 421 to the processing unit 30 when the inner input portion 42 is operated once within a specific period. After the processing unit 30 receives the first signal 421, the processing unit 30 can activate the input device 12 of the outer body 15. In the meantime, the input device 12 is used for inputting the verification password 121 to the processing unit 30. Then, verification unit 14 of the processing unit 30 of the electronic lock 1 determines whether the verification password 121 matches the master password 131 stored in the storing unit 13. In practical application, the master password 131 can be a default password stored by the manufacturer when the electronic lock 1 is sold in the market for the first time. When the verification unit 14 of the processing unit 30 determines that the verification password 121 matches the master password 131, the locking mechanism 10 of the electronic lock 1 performs an unlocked operation, such that a user is capable of opening the door to get indoors or go outdoors. Furthermore, the verification unit 14 of the processing unit 30 simultaneously logs in the management menu, such that the user is capable of using items shown on the management menu to set up relative options of the electronic lock 1. In addition, when the input device 12 is not operated to output the first signal 421, the processing unit 30 logs out or is not allowed to log in the manage menu of the electronic lock 1.

When the processing unit 30 logs in the manage menu of the electronic lock 1, the manage menu of the electronic lock 1 can perform multi-functions, provided as follows:

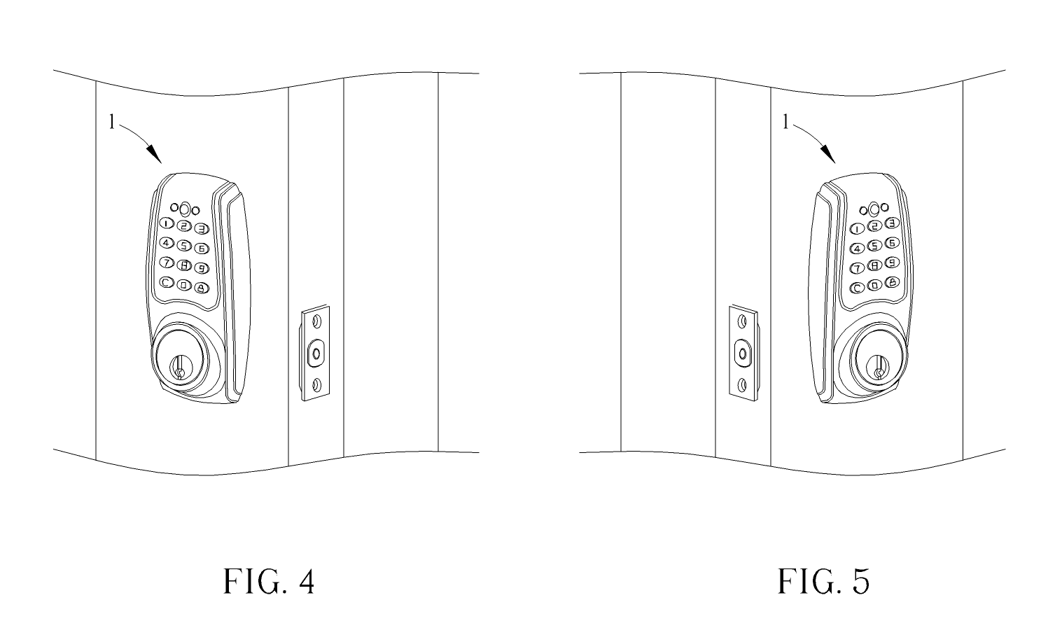

1. The first controlling item of the management menu is used for setting a left-handed mode or a right-handed mode of the electronic lock 1, wherein the left-handed mode of the electronic lock 1 corresponds to the left handed door shown in FIG. 4, and the right-handed mode of the electronic lock 1 corresponds to the left-handed door shown in FIG. 5. More detailed description illustrating mechanisms to set left-handed mode and the right-handed mode of the electronic lock 1 is provided as follows.

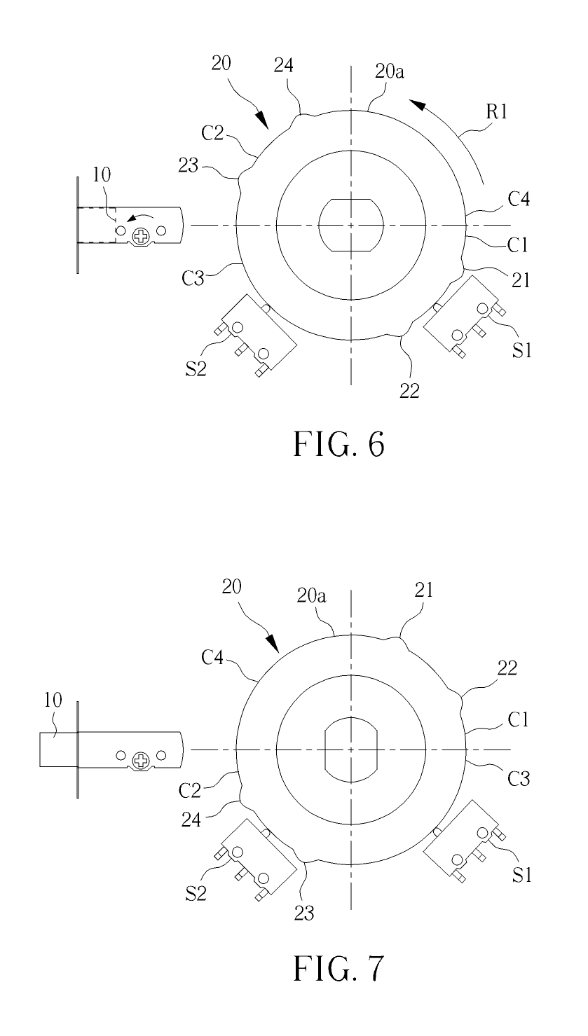

Please refer to FIG. 6 to FIG. 9. FIG. 6 to FIG. 9 are respectively diagrams illustrating that the electronic lock 1 is installed on the left-handed door according to the embodiment of the present invention. As shown in FIG. 6 to FIG. 9, the electronic lock 1 further includes a rotational actuator 20, a first switch unit S1 and a second switch unit S2. The rotational actuator 20 is capable of being driven by a motor (not shown) to rotate in a first direction R1 and a second direction R2 opposite to the first direction R1. In this embodiment, the locking mechanism 10 moves leftwards when the rotational actuator 20 rotates in the first direction R1, and the locking mechanism 10 moves rightwards when the rotational actuator 20 rotates in the second direction R2.

Furthermore, the rotational actuator 20 includes a peripheral surface 20a, a first protrusion 21, a second protrusion 22, a third protrusion 23 and a fourth protrusion 24. The peripheral surface 20a is composed of a first curved surface C1, a second curved surface C2 opposite to the first curved surface C1, a third curved surface C3 located between the first curved surface C1 and the second curved surface C2 and a fourth curved surface C4 opposite to the third curved surface C3. In addition, the first curved surface C1 is formed between the first protrusion 21 and the second protrusion 22, and the second curved surface C2 is formed between the third protrusion 23 and the fourth protrusion 24.

At first, the rotational actuator 20 is driven to rotate in the first direction R1. When the rotational actuator 20 rotates in the first direction R1, the second protrusion 22 of the rotational actuator 20 touches the first switch unit S1 prior to that the third protrusion 23 of the rotational actuator 20 touches the second switch unit S2. In other words, the first switch unit S1 is activated prior to that the second switch unit S2 is activated when the rotational actuator 20 rotates in the first direction R1, as shown in FIG. 6 and FIG. 7. Accordingly, the processing unit 30 of the electronic lock 1 determines that the electronic lock 1 is installed on the left-handed door. In the meanwhile, the locking mechanism 10 moves leftwards to a stretched position and the electronic lock 1 is in a locked status. Accordingly, the electronic lock 1 is considered to be initially installed on the left-handed door and in the locked status.

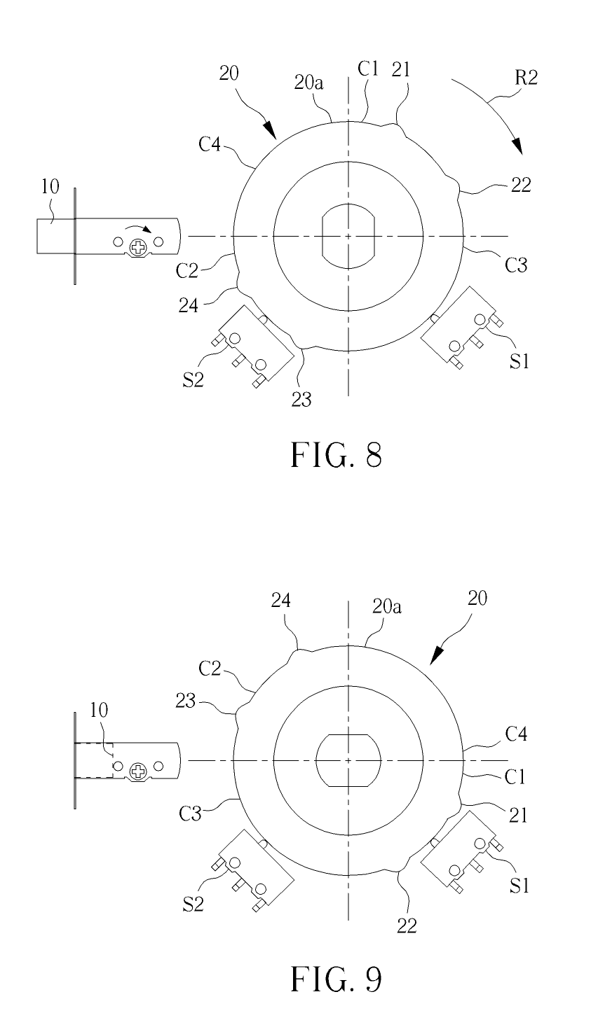

In this embodiment, when the electronic lock 1 is confirmed to be installed on the left-handed door, the method further includes a latch-restoring step for driving the rotational actuator 20 to rotate in the second direction R2. As shown in FIG. 8 and FIG. 9, the rotational actuator 20 can drive the locking mechanism 10 to move rightwards. During the process of the latch-restoring step, the third protrusion 23 of the rotational actuator 20 touches the second switch unit S2 prior to that the second protrusion 22 of the rotational actuator 20 touches the first switch unit S1, such that the locking mechanism 10 is moved rightwards to a restoring position.

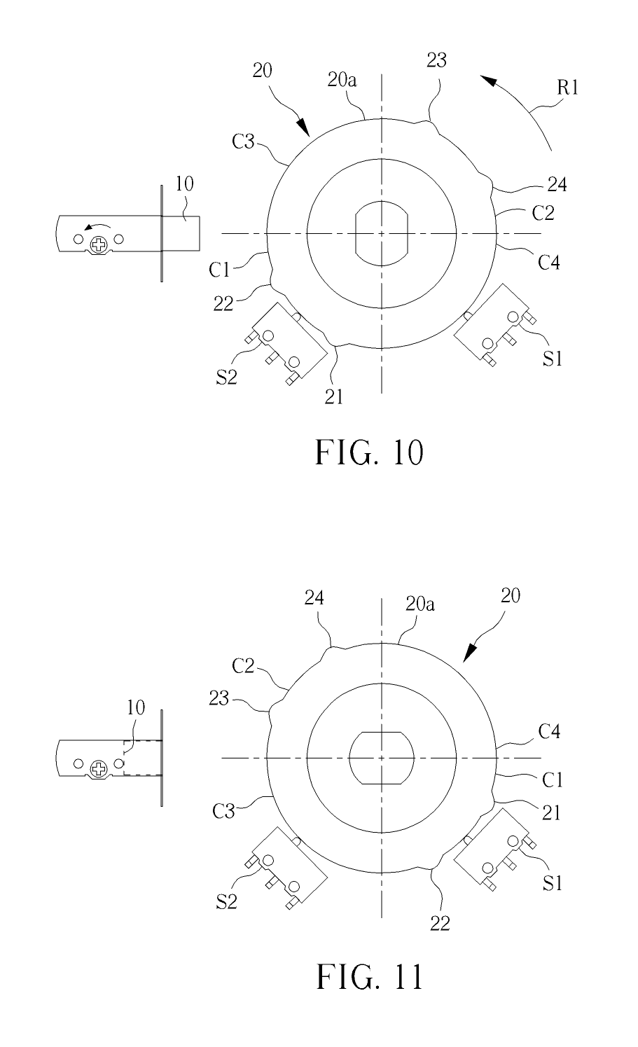

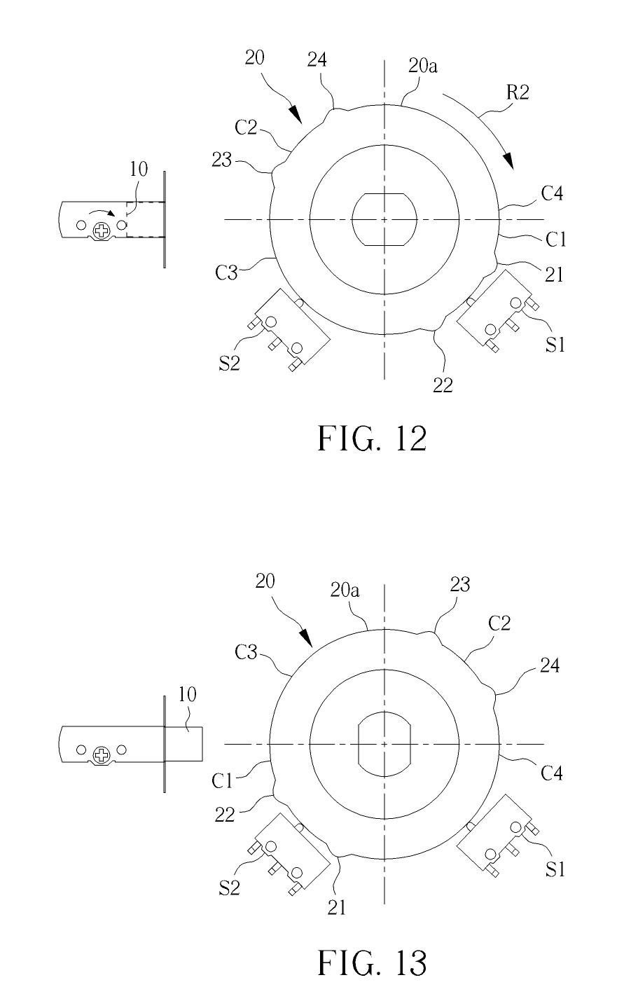

Please refer to FIG. 10 to FIG. 13. FIG. 10 to FIG. 13 are respectively diagrams illustrating that the electronic lock 1 is installed on the right-handed door according to the embodiment of the present invention. As shown in FIG. 10 to FIG. 13, at first, the rotational actuator 20 is driven to rotate in the first direction R1. When the rotational actuator 20 rotates in the first direction R1, the second protrusion 22 of the rotational actuator 20 touches the second switch unit S2 prior to that the first protrusion 21 of the rotational actuator 20 touches the first switch unit S1. In other words, the second switch unit S2 is activated prior to that the first switch unit S1 is activated when the rotational actuator 20 rotates in the first direction R1. Accordingly, the processing unit 30 of the electronic lock 1 determines that the electronic lock 1 is installed on the right-handed door. In the meanwhile, the locking mechanism 10 moves leftwards to the retracted position. Accordingly, the locking electronic lock 1 is considered to be initially installed on the left-handed door and in a retracted status.

As a result, the electronic lock 1 can be set as a right-handed mode. When the rotational actuator 20 is rotated in the first direction R1, the locking mechanism 10 is in the unlocked status. When the rotational actuator 20 is rotated in the second direction R2, the locking mechanism 10 is in the locked status.

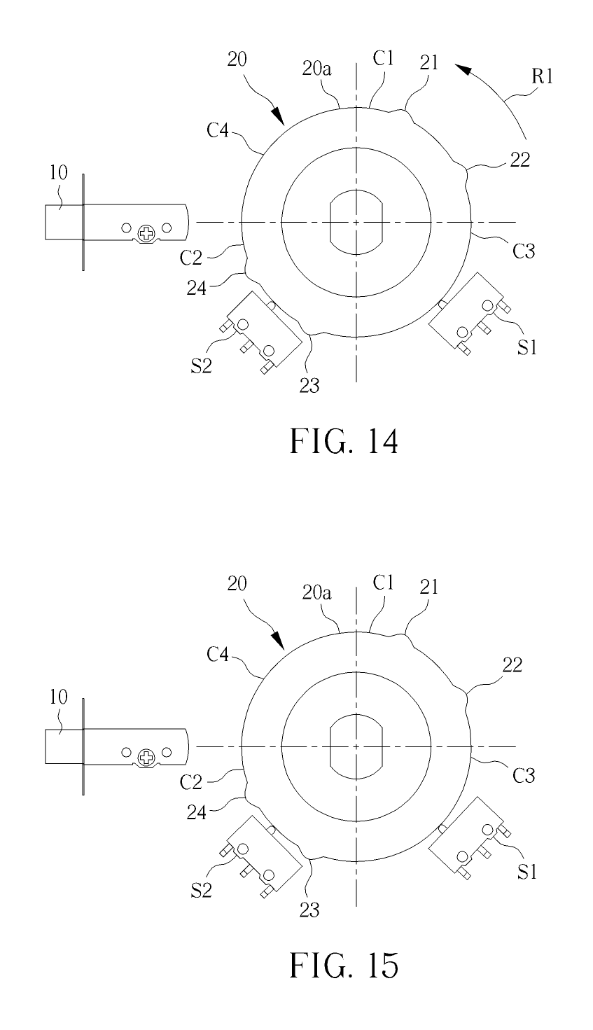

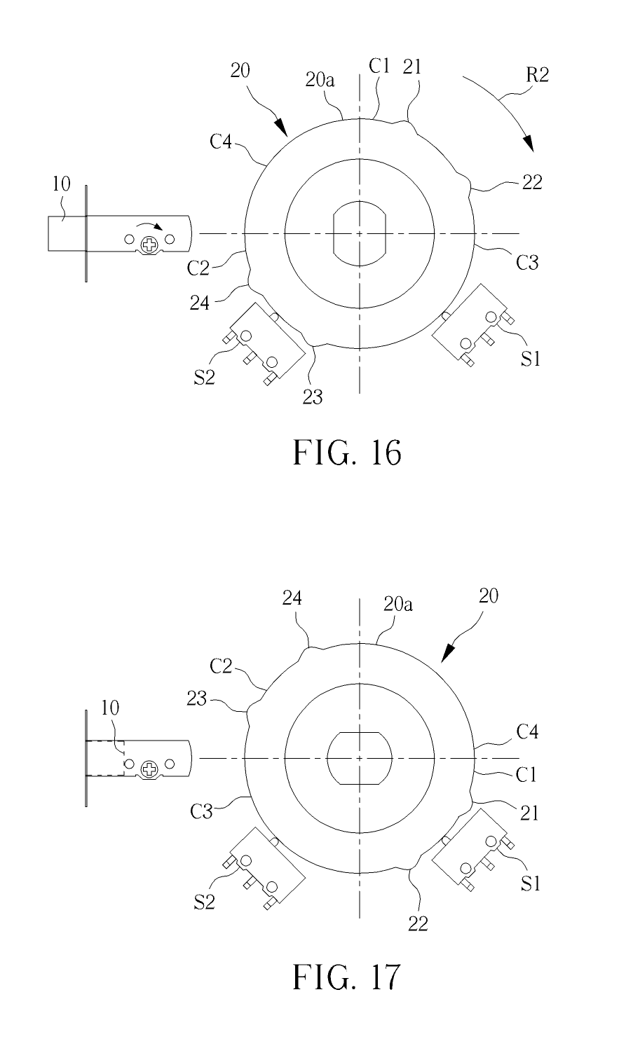

Please refer to FIG. 14 to FIG. 17. FIG. 14 to FIG. 17 are respectively diagrams illustrating the electronic lock 1 in a constrained status is installed on the left-handed door according to the embodiment of the present invention. As shown in FIG. 14 and FIG. 15, when the rotational actuator 20 is rotated in the first direction R1, the locking mechanism 10 is in an abnormal status if the rotational actuator 20 can not touch the second switch S2 and the first switch S1. In the meantime, the motor reverse the rotational actuator 20 to rotate in the second direction R2, as shown in FIG. 16 and FIG. 17. If the third protrusion 23 of the rotational actuator 20 touches the second switch S2 prior to the second protrusion 22 touches the first switch S1, the electronic lock 1 is considered to be initially installed on the left-handed door and in the stretched status. The locking mechanism 10 can be moved rightwards to be in the unlocked status.

As a result, the electronic lock 1 can be set as the left-handed mode, i.e. the locking mechanism 10 is in the locked status when the motor drives the rotational actuator 20 to rotate in the first direction R1, and the locking mechanism 10 is in the unlocked status when the motor drives the rotational actuator 20 to rotate in the second direction R2.

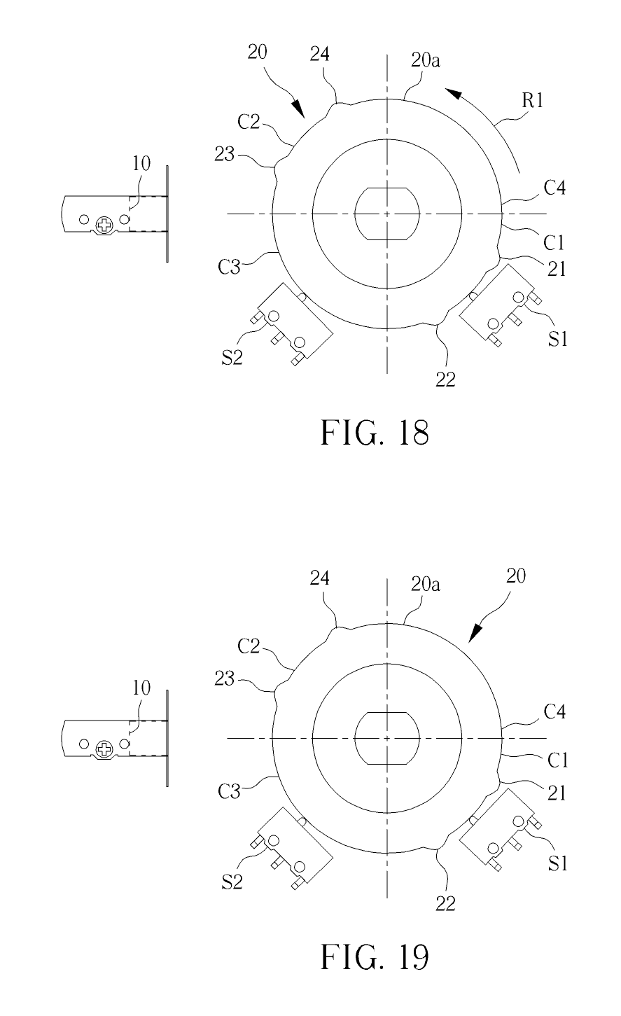

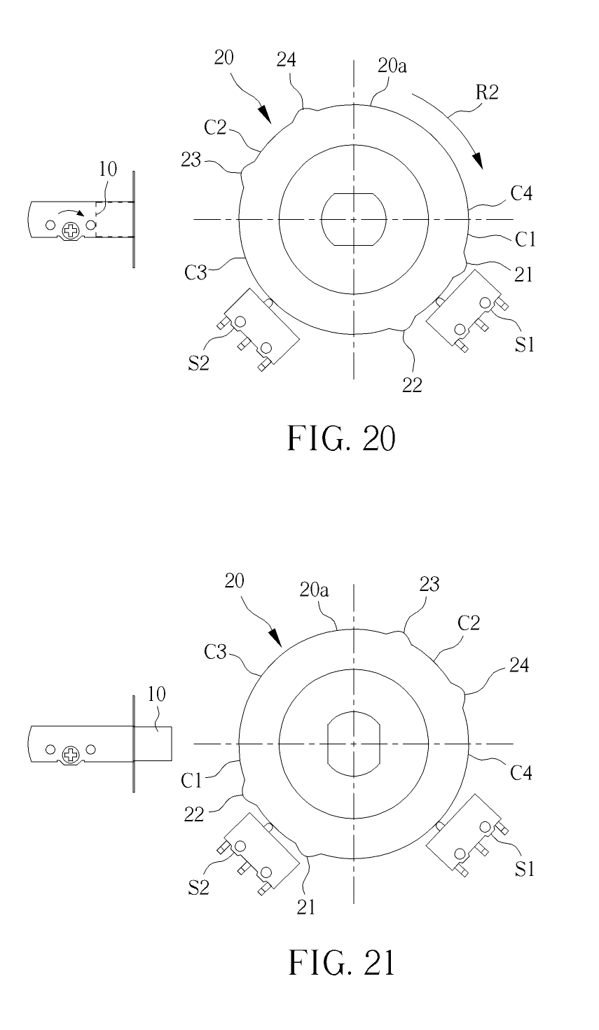

Please refer to FIG. 18 to FIG. 21. FIG. 18 to FIG. 21 are respectively diagrams illustrating the electronic lock 1 in the constrained status is installed on the right-handed door according to the embodiment of the present invention. As shown in FIG. 18 and FIG. 19, when the rotational actuator 20 is rotated in the first direction R1, the locking mechanism 10 is in an abnormal status if the rotational actuator 20 can not touch the second switch S2 and the first switch 51. In the meantime, the motor reverse the rotational actuator 20 to rotate in the second direction R2, as shown in FIG. 20 and FIG. 21. If the first protrusion 21 of the rotational actuator 20 touches the first switch S1 prior to the second protrusion 22 touches the second switch S2, the electronic lock 1 is considered to be initially installed on the right-handed door and in the restricted status. The locking mechanism 10 can be moved rightwards to be in the locked status.

As a result, the electronic lock 1 can be set as the right-handed mode, i.e. the locking mechanism 10 is in the unlocked status when the motor drives the rotational actuator 20 to rotate in the first direction R1, and the locking mechanism 10 is in the locked status when the motor drives the rotational actuator 20 to rotate in the second direction R2.

On the other hand, the verification unit 14 of the processing unit 30 further determines whether the verification password 121 matches the user password 133 stored in the storing unit 13 when the verification unit 14 of the processing unit 30 determines that the verification password 121 does not match the master password 131. When the verification unit 14 of the processing unit 30 determines that the verification password 121 does not match the master password 131 but matches the user password 133, the locking mechanism 10 of the electronic lock 1 performs an unlocked operation, such that the user is capable of opening the door to get indoors or go outdoors. Simultaneously, the processing unit 30 does not log in the management menu, such that the user is incapable of using items shown on the management menu to set up relative options of the electronic lock 1.

In practical application, there can be many people who use the electronic lock 1 in daily life. If every one of the people knows the master password 131, each of the people has right to access the management menu and to modify the contents stored in the management menu. Accordingly, it might result in some security issues as the electronic lock 1 is used in public. As a result, the people can be authorized to use the electronic lock 1 by the user password 133 for different groups. For example, one of two groups is for general users, such as customers, residents in community and so on, and the other of the two groups is for administrators who are in charge of community security, fixing technicians and so on.

In practical application, one of the two groups, i.e. general users, knows the user password 133 only. They can use the user password 133 for activating the locking mechanism 10 of the electronic lock 1 to perform the unlocked operation, such that the general users are capable of opening the door to get indoors or go outdoors in daily life. Furthermore, the other of the two groups, i.e. administrators, knows the master password 131. In other words, only the other of the two groups has the authority to access the management menu, so as to set up relative options of the electronic lock 1. Accordingly, it can help to decrease the security issues when the electronic lock 1 is used in public.

It should be noticed that the storing unit 13 can store more than one user password 133 for an amount of the general users. In other words, an amount of the user password 133 is not limited to those mentioned in the aforesaid embodiment, and it depends on practical amount of the general users.

On the other hand, when the verification unit 14 of the processing unit 30 determines that the verification password 121 matches neither the master password 131 nor the user password 133, the locking mechanism 10 of the electronic lock 1 does not perform the unlocked operation, such that the user is incapable of opening the door to get indoors or go outdoors. Moreover, the processing unit 30 does not log in the management menu either, such that the user is incapable of using items shown on the management menu to set up relative options of the electronic lock 1.

In addition, the processing unit 30 can further count an accumulated number of times of the verification password 121 not matching the master password 131 and determines whether the accumulated number is more than a predetermined number. In other words, the predetermined number can be a default value meaning that the predetermined number can be embedded by users or manufacturers in advance. In this embodiment, the default value can be four times.

Furthermore, when the processing unit 30 determines the accumulated number of times of the verification password 121 not matching the master password 131 is more than the predetermined number, an alarm unit (not shown in figures) of the electronic lock 1 can send an alarm, so as to notice that the number of times of improper operation of the electronic lock 1 is over a tolerant value. In the meanwhile, the electronic lock 1 stops for a predetermined period due to security concern. Similarly, the predetermined period can be embedded in the system by the users or the manufacturers in advance. In this embodiment, the predetermined period can be, but not limited to, 1 minute. Afterwards, the electronic lock 1 can be re-powered on and remains in the standby status. On the other hand, the electronic lock 1 allows the user to try another verification password until the processing unit 30 determines that the accumulated number of times of the verification password 121 matching neither the master password 131 nor the user password 133 is more than the predetermined number.

Furthermore, the locking mechanism 10 of the electronic lock 1 is desired to perform the unlocked operation when the processing unit 30 receives the unlocked signal transmitted from the remote control device 16. In other words, the user can utilize the remote control device 16 to operate the electronic lock 1 to perform the unlocked operation, so as to enhance flexibility of the electronic lock 1 in use.

In addition, the management menu can include the other third controlling items in this embodiment, which are respectively a modification controlling item, an adding controlling item and a deletion controlling item. More detailed description for the other three controlling items is provided as follows.

2. The second controlling item of the management menu is used for modifying the master password. When the verification unit 14 of the processing unit 30 determines that the verification password 121 matches the master password 131, the processing unit 30 can log in the management menu and the user can utilize the second controlling item of the management menu to modify the master password 131. Since there is only one way to access the management menu with the unique master password 131, changing the master password 131 regularly prevents the people with no authority to use the electronic lock 1 from accessing to the electronic lock 1, so as to secure of the electronic lock 1 in use.

3. The third controlling item of the management menu is used for adding another user password or to add another remote control device. Since a number of users of the electronic lock 1 can be increasing, it is required to add a new user password as well as add a new remote control device for convenience. When the verification unit 14 of the processing unit 30 determines that the verification password 121 matches the master password 131, the processing unit 30 can log in the management menu and the user can utilize the third controlling item of the management menu to add the new user password and the corresponding new remote control device, so as to increase the flexibility of application of the electronic lock 1 in use.

It should be noticed that the remote control device 16 can be a remote control device in the field of wireless communication technology. For example, the remote control device can be a remote control, a RFID sensing card, a mobile phone, a Personal Digital Assistant, a remote control computer, a tablet computer and so on. The wireless communication technology can conform to an infrared technology, a Radio Frequency Identification technology, a Bluetooth, a WiFi technology and so on. Accordingly, the electronic lock 1 can be equipped with an infrared ray sensor, a Radio Frequency Identification sensor, a Bluetooth sensor, an Ethernet connector, a wireless communication module and so on.

In addition to utilizing the verification password which matches the master password to log in the management menu of the electronic lock for adding the new user password or the new remote control device, it is adopted to log in the management menu of the electronic lock instead of utilizing the verification password which matches the master password that times which the inner input portion 42 is operated is used for adding the new user password. The method is illustrated as follows:

When the inner input portion 42 is operated once within a specific period and then the new user password is input by the input device 12, the new user password input by the input device 12 will be stored as a new first user password by the third controlling item. When the inner input portion 42 is operated twice within a specific period and then the new user password is input by the input device 12, the new user password input by the input device 12 will be stored as a new second user password by the third controlling item.

4. The fourth controlling item of the management menu is used for deleting the at least one user password or the at least one remote control device. Since the number of users of the electronic lock 1 can be decreasing, it is required to delete at least one extra user password as well as delete at least one extra remote control device for convenience. When the verification unit 14 of the processing unit 30 determines that the verification password 121 matches the master password 131, the processing unit 30 can log in the management menu and the user can utilize the fourth controlling item of the management menu to delete the extra at least one user password and the extra corresponding new remote control device, so as to increase the flexibility of application of the electronic lock 1 in use.

In addition, if the user does not want to be disturbed and the electronic lock 1 is desired to be locked from the indoor side, the user can operate the inner input portion 42 over the specific period, the inner input portion 42 outputs a second signal 423. When the processing unit 30 receives the second signal 423, the processing unit 30 disables the input device 12. In such a manner, the electronic lock 1 can not be unlocked even if the qualified user password or the remote control device 16 is adopted, so as to lock the electronic lock 1 from the indoor side.

In contrast to the prior art, the only way to log in the management menu of the electronic lock is to operate the inner input portion of the inner body, i.e. the management menu of the electronic lock can not be logged in by operation of the outer body. It can prevent a thief from logging in the management menu of the electronic lock by operating the outer body, so as to enhance security of the electronic lock. In addition, the electronic lock can to be switched to the left-handed mode or to the right-handed mode by operating the input device and the management menu of the electronic lock. Accordingly, since the electronic lock is capable of being installed on a left-handed door as well as a right-handed door by switching the electronic lock to be in the corresponding mode, it can enhance convenience of installation, possess humanized electronic interface with functions of modification, addition, and deletion for the password, and thus it can further reduce costs.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for operating an electronic lock, the electronic lock comprising a processing unit, an inner body and an outer body, the inner body comprising an inner input portion, the outer body comprising an input device, the method comprising:
operating the inner input portion of the inner body to output various signals according to operation of the inner input portion, wherein the various signals comprises a first signal; and
utilizing the input device to log in a manage menu of the electronic lock when the processing unit receives the first signal, wherein the manage menu of the electronic lock comprises a first controlling item for setting a left-handed mode or a right-handed mode by the input device.

2. The method of claim 1, further comprising:
a master password being stored in the electronic lock, utilizing the input device to input a verification password when the processing unit receives the first signal, the input device being allowed to login the manage menu of the electronic lock when the processing unit determines that the verification password matches the master password, and the processing unit logging out or being not allowed to log in the manage menu of the electronic lock when the input device is not operated to output the first signal.

3. The method of claim 1, wherein the inner input portion outputs the first signal when the inner input portion is operated once within a specific period, the inner input portion outputs a second signal when the inner input portion is continuingly operated over the specific period, and the processing unit disables the input device when the processing unit receives the second signal.

4. The method of claim 2, wherein the manage menu of the electronic lock comprises a second controlling item for modifying the master password.

5. The method of claim 2, wherein a user password is stored in the electronic lock, the input device is not allowed to log in the manage menu of the electronic lock when the processing unit determines that the verification password matches the user password.

6. The method of claim 5, wherein the electronic lock performs the unlocked operation when the processing unit receives an unlocked signal transmitted from a remote control device.

7. The method of claim 6, wherein the manage menu of the electronic lock further comprises a third controlling item for adding a new user password or a new remote control device.

8. The method of claim 7, wherein the manage menu of the electronic lock further comprises a fourth controlling item for deleting the user password or the remote control device.

9. The method of claim 2, further comprising:
the electronic lock stops for a predetermined period when the processing unit determines an accumulated number of times of the verification password not matching the master password is more than a predetermined number.

10. The method of claim 2, further comprising:
the electronic lock sending an alarm when the processing unit determines an accumulated number of times of the verification password not matching the master password is more than a predetermined number.

11. The method of claim 2, wherein utilizing the input device to input the verification password comprises utilizing the input device to input at least one or a combination of the verification passwords selected from a group consisting of a numeral, a pattern, a motion, a gesture, a finger print, an iris feature, a sound, a facial expression, and a biometric characteristic.
